(19) United States
(12) Patent Application Publication
(10) Pub. No.: US 2007/0013864 A1
(43) Pub. Date: Jan. 18, 2007

(54) UTILITY TOOLS AND APPARATUS AND METHODS FOR SECURING UTILITY TOOLS

(76) Inventor: Daniel R. Dietz, Sugar Land, TX (US)

Correspondence Address: Jimmy Mark Gilbreth, P. O. Box 2428, Bellaire, TX, 77402-2428, US

(21) Appl. No.: 11/160,854

(22) Filed: Jul. 13, 2005

(51) Int. Cl. G02C 3/00

(52) U.S. Cl. 351/155

(57) ABSTRACT

A tool system comprising eyeglasses and a tool magnetically coupled together.

### BACKGROUND OF THE INVENTION

1. Field of the Invention

The present invention relates to utility tools. In another aspect, the present invention relates to utility tools and to apparatus and methods for securing utility tools. In even another aspect, the present invention relates to utility tools, and apparatus and methods for securing utility tools to a user's body. In still another aspect, the present invention relates to utility tools and to apparatus and methods for securing utility tools to a user's head.

2. Description of the Related Art

Visit an automotive garage, construction site, drafting room, operating room, office, art studio, kitchen, or anywhere else where people use tools and one thing becomes clear quickly: a person simply does not have enough hands.

It is not unusual to see a mechanic holding a flashlight between the teeth or tucking a screw driver behind an ear, or a draftsperson to have one or more pencils behind one or both ears, or for a surgeon to have a light clipped to headgear. Bicyclists, hikers and mountain climbers sometimes utilize a head harness upon which is mounted a light.

A large percentage of people wear glasses, either prescription glasses, over the counter reading glasses, non-corrective sun glasses, or worked related eyewear. A solution to securing and/or storing tools while working and while providing easy access, would be to affix them to glasses.

U.S. Pat. Nos. 3,350,552, Des. 269,125, and 4,616,297, all disclose optical or non-optical frames comprising a light, with U.S. Pat. No. 3,647,059 comprising a cylindrical accessory receptacle.

U.S. Pat. No. 6,425,664, issued Jul. 30, 2002 to Liu et al., for folding device of glasses, discloses glasses with a body having two frames, and two temples that may be folded and expanded. Two magnetic attraction structures are mounted on the two temples, so that the two temples may magnetically attract each other when the glasses are disposed at a folded status. In such a manner, when the glasses are disposed at a folded status, and are hung on the pocket of a clothing, a first temple is placed in the pocket of the clothing, and a second temple is exposed outward from the pocket of the clothing, so that the two temples may attract and bond each other by the magnetic attraction structures to secure the glasses on the pocket of the clothing. Thus, the glasses can be rigidly and safely placed in the pocket, and can be removed from the pocket conveniently.

U.S. Pat. No. 6,568,805, issued May 27, 2003 to Dietz, for magnetic buckle for eyeglasses, discloses an eyeglasses clasp for maintaining eyeglasses on a clothing material. The clasp comprises magnetic means engaged with the eyeglasses temple bars and aligned with the eyeglasses frame body midpoint when the temple bars are closed. The magnets are in attractive magnetic communication when the temple bars into the closed position. The frame body and closed temple bars are then positioned on one side of a clothing material. The second temple bar is then pivoted into the close position such that it is on the other side of the clothing material. With the temple bars closed, the magnets are in attractive magnetic communication and impart a gripping force on the article of clothing. The gripping force substantially prevents movement between the temple bars and the clothing material.

U.S. Patent Publication No. 2004/01 35966, published Jul. 15, 2004 to Dietz for an eyeglass assembly with removable auxiliary eyeglasses attachment. The eyeglasses assembly comprises at least one magnetic hinge that holds a removable, auxiliary eyeglasses attachment onto eyeglasses. The magnetic hinge allows the user to pivot the auxiliary eyeglass attachment into an “up” position when not in use. The magnetic hinge also disengages to allow the auxiliary eyeglass attachment to be removed from the eyeglasses when desired. Moreover, the magnetic hinge holds the auxiliary eyeglasses attachment in place after the user rotates the auxiliary attachment into the “up” position. The eyeglasses assembly additionally comprises magnets that secure the auxiliary eyeglass attachment to the eyeglasses when in the “down” position and in use

U.S. Patent Publication No. 2004/0183993, published Sept. 23, 2004 to Dietz for an eyeglasses temple bar clasp for maintaining eyeglasses on a material such as clothing. The clasp comprises temple bars comprising magnetic material such that the temple bars magnetically attract each other through the material when the temple bars are closed. The clasp is used by pivoting one of the temple bars into the closed position. The frame body and closed temple bar are then positioned on one side of the material. The second temple bar is then pivoted into the closed position such that it is on the other side of the material. With the temple bars closed, the temple bars impart a gripping force on the material, thus clasping the eyeglasses to the material.

U.S. Patent Publication No. 2004/0239873, published Dec. 2, 2004 to Dietz for a temple tip eyeglasses clasp for maintaining eyeglasses on a material. The clasp comprises magnets engaged with the eyeglasses temple tips that align with each other when the temple bars are closed. The magnets are thus in attractive magnetic communication through the material when the temple bars are closed. The clasp is used by pivoting one of the temple bars into the closed position. The frame body and closed temple bar are then positioned on one side of the material. The second temple bar is then pivoted into the closed position such that it is on the other side of the material. With the temple bars closed, the magnets are in attractive magnetic communication and impart a gripping force on the material.

U.S. Pat. No. 6,848,787, issued Feb. 1, 2005 to Dietz, discloses an offset eyeglasses clasp for maintaining eyeglasses on a clothing material. The clasp comprises at least one magnetic means engaged with the eyeglasses temple bars that align with each other but not with the eyeglasses frame body midpoint when the temple bars are closed. The magnets are in attractive magnetic communication when the temple bars are closed. The clasp is used by pivoting one of the temple bars into the closed position. The frame body and closed temple bar are then positioned on one side of a clothing material. The second temple bar is then pivoted into the closed position such that it is on the other side of the clothing material. With the temple bars closed, the magnets are in attractive magnetic communication and impart a gripping force on the article of clothing. The gripping force substantially prevents relative movement between the temple bars and the clothing material.

While the above patents and publications disclose eyeglasses which may be more securely fastened to clothing and the like, there is no disclosure of securing tools to the glasses.

There is a need for improvements in the utility tool art.

There is another need in the art for utility tools, and apparatus and methods for securing utility tools, while maintaining ease of access.

There is even another need in the art for utility tools, and to apparatus and methods for securing utility tools to a user's body.

There is yet another need in the art for utility tools, and to apparatus and methods for securing utility tools to a user's head.

These and other needs in the art will become apparent to those of skill in the art upon review of this specification.

### SUMMARY OF THE INVENTION

It is an object of the present invention to provide for improvements in the utility tool art.

It is another object of the present invention to provide for utility tools, and apparatus and methods for securing utility tools.

It is another object of the present invention to provide for utility tools, and to apparatus and methods for securing utility tools to a user's body.

It is another object of the present invention to provide for utility tools, and apparatus and methods for securing utility tools to a user's head.

These and other objects will become apparent to those of skill in the art upon review of this specification.

According to one embodiment of the present invention there is provided a tool system comprising an optical or non-optical frame and a tool magnetically coupled to the frame.

According to another embodiment of the present invention there is provided a tool system comprising an optical or non-optical frame having a first magnetic coupling member, and a tool comprising a second magnetic coupling member. The first magnetic coupling member and the second magnetic coupling member magnetically interact to magnetically couple the frame to the tool.

According to even another embodiment of the present invention, there is provided a temple bar for an optical or non-optical frame, comprising an elongated body member having a first end adapted for connection to the frame, a second end for shaping to fit over a wearer's ear, and a magnet supported to the elongated body member.

According to still another embodiment of the present invention, there are provided methods of making and using the above embodiments.

These and other embodiments of the present invention will become apparent to those of skill in the art upon review of this specification.

### BRIEF DESCRIPTION OF THE DRAWINGS

In the drawings, like reference numbers refer to like items.

### DETAILED DESCRIPTION OF THE INVENTION

An optical frame may be thought of as typical eyeglasses with lenses, whether corrective, protective, filtering, or merely ornamental. Such typical eyeglasses consist of a main frame body that houses two lenses on either side of a nose piece. Attached to the frame body are two temple bars that extend from two ends of the frame body. The temple bars may be rigidly attached or may pivot between an open position perpendicular with the frame body and a closed position parallel with the frame body. The temple bars and nose piece support the frame on the head of the wearer.

A non-optical frame may be thought of as eyeglasses minus the lens. Such a typical non-optical frame consists of two temple bars which are joined by a nose piece. While the present invention is mostly described in terms of an optical frame, it should be understood, that the present invention finds utility with both optical frames and non-optical frames. The temple bars may be hinged or rigidly connected.

Regarding both optical and non-optical frames, it should be understood that the frame body, lens, temple bars, temple tips, and hinges are well known to those of skill in the art and will not be discussed in detail.

The utility system of the present invention may be generally described as comprising an optical or non-optical frame to which is magnetically coupled some sort of tool. Non-limiting examples of suitable tools include flashlights, writing instruments, mechanical tools, measurement instruments, audio attachments, kitchenware, and telescoping tools such as a pointer. Of course, the tool would have to be able to magnetically couple with the frame.

Non-limiting examples of mechanical tools would include wrenches, screw drivers, socket drivers, pliers, files, knives, scrapers, punch, needle, clippers, scissors, saw, drill bits, wire strippers, surgical tools, dental tools, and veterinarian tools.

Non-limiting examples of writing instruments includes pens, pencils, mechanical pencils, markers, highlighters, scribe, brush, ink pen, chalk, crayons, laser pointers, and pastels.

Non-limiting examples of measurement instruments includes thermometers, infrared sensors, barometers, hygrometer, infrared measurement devices, ruler, caliper, and sound detection equipment.

Non-limiting examples of kitchenware includes cooking thermometers, knives, and utilsels.

Non-limiting examples of audio attachments include speakers and/or microphones in communication with electronic devices such as phones, recorders, transmitters, any sound playing device, and any sound controlled device.

Generally, this tool may be magnetically coupled to any part of the frame, including to the main frame body, one or both of the temple bars, to the bridge, nose rest, and the like, and the tool will be provided with a magnet or magnetically attractive surface accordingly. In addition, all or part of the optical and/or non-optical frame maybe magnetized.

The magnetic coupling between the frame and the tool may be accomplished by employment of a pair of mated magnets on both the frame and the tool, or by having a magnet on the frame or tool, and a magnetically attractive surface on the other.

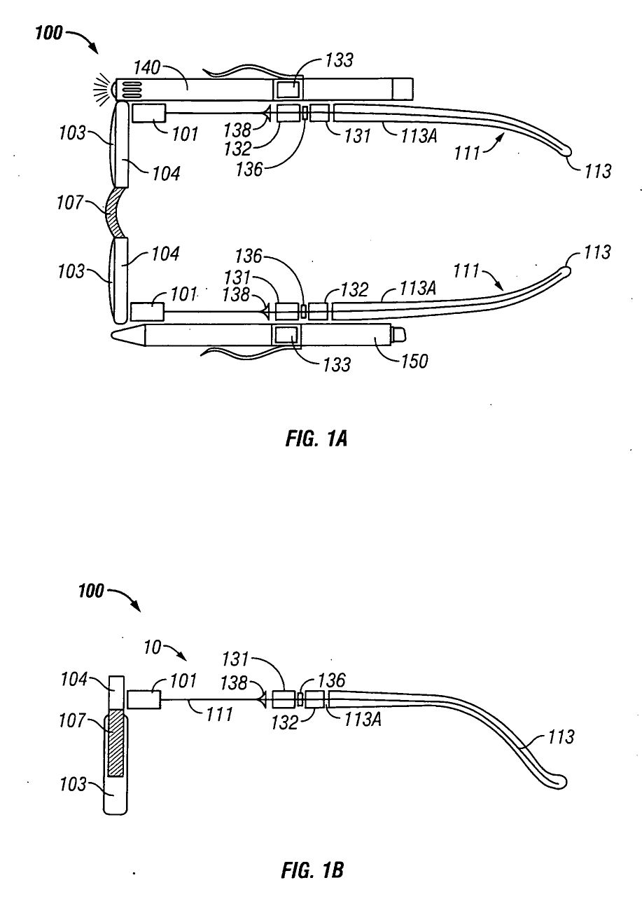

The present invention is most conveniently described by reference to the drawings. Referring now to FIGS. 1A and 1B, which are top and side views respectively, of one embodiment of the present system, a tool system 10, comprising frame 100 having a common frame body 104, lens 103, nose rest 107, wire type temple bars 111, hinge spring 101, and temple tips 113. Mounted on temple bars 111 and secured between temple tip end 113A and stop 138, are magnet 131 and ferrous metal member 132, spaced by optional spacer 136. Temple bar 111 passes directly thru a center passage in doughnut shaped magnet 131 and ferrous metal member 132. In the embodiment as shown, tool system 10 further includes utility tools such as flashlight 140 or pen 150, each of which comprises a magnet 133 for magnetically interacting with magnet 132 or metal member 131 to affix the utility tool to frame 100.

Throughout the various embodiments herein, magnets 132 on the temple bars may or may not align and magnetically couple when the temple bars are folded, depending upon the desired design. Additionally, one or more magnets 132 maybe utilized and positioned anywhere along temple bars as desired.

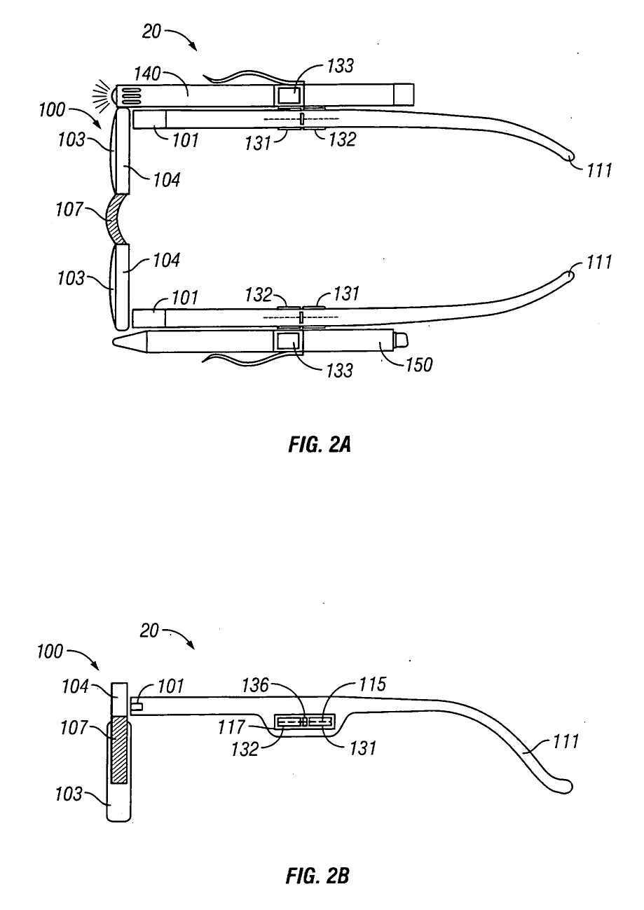

Referring additionally to FIGS. 2A and 2B, which are top and side views respectively, of one embodiment of the present invention, a tool system 20 comprising frame 100 having a common frame body 104, lens 103, nose rest 107, temple bars 111, and hinge spring 101. Mounted within a window 117 defined by temple bars 111 are magnet 132 and ferrous metal member 131, spaced by optional spacer 136. A holding pin 118 passes thru and secures magnet 131 and ferrous metal member 132 within window 117. In the embodiment as shown, tool system 20 further includes utility tools such as flashlight 140 or pen 150, each of which comprises a magnet 133 for magnetically interacting with magnet 132 or metal member 131 to affix the utility tool to frame 100.

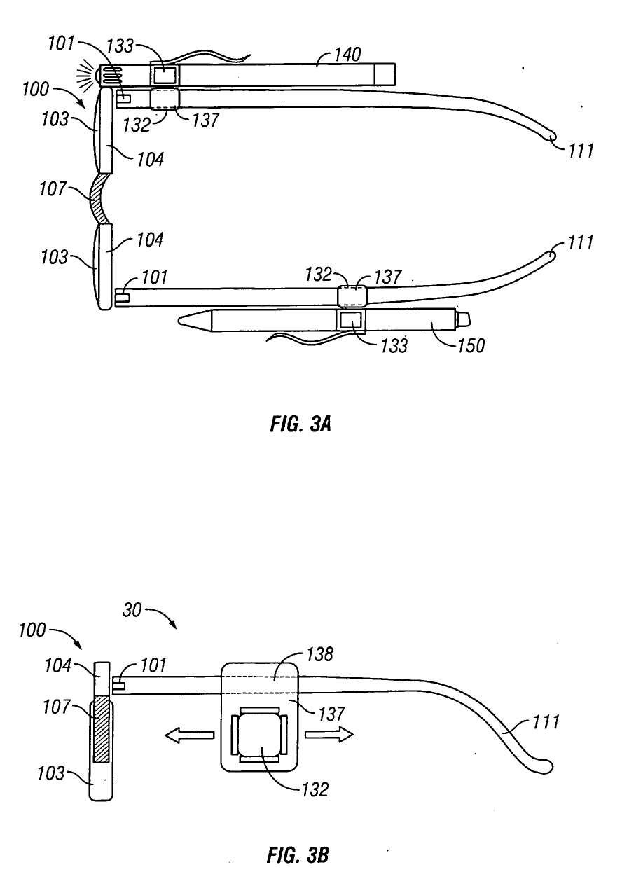

Referring additionally to FIGS. 3A and 3B, which are top and side views respectively, of one embodiment of the present invention, a tool system 30 comprising frame 100 having a common frame body 104, lens 103, nose rest 107, temple bars 111, and hinge spring 101. Magnet holder 138 comprises a magnet 132, although it could alternatively comprise a magnetically attractive surface for receiving a magnet. Magnet holder 138 defines a passage 138 thru which temple bar 111 is friction fit allowing magnet holder 138 to be slidably attached to temple bar 111. This allows for magnet holder 138 to be slidably positioned along temple bar 111 as desired. It should be seen that any suitable number of magnet holders 138 may be positioned on temple bar 111. In the embodiment as shown, tool system 30 further includes utility tools such as flashlight 140 or pen 150, each of which comprises a magnet 133 for magnetically interacting with magnet 132 to affix the utility tool to frame 100.

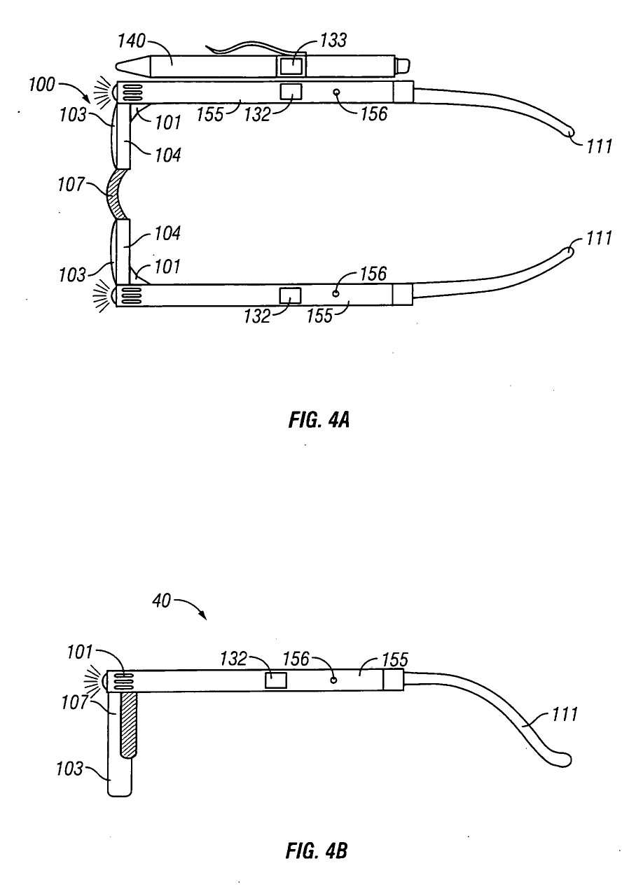

Referring additionally to FIGS. 4A and 4B, which are top and side views respectively, of one embodiment of the present invention, a tool system 40 comprising frame 100 having a common frame body 104, lens 103, nose rest 107, temple bars 111, and hinge spring 101. Temple bars 111 comprise flashlight 155, either integral with temple bar 111 or housed therein, operable by switch 156. In the embodiment as shown, tool system 40 further includes utility tools such as pen 140 which comprises a magnet 133 for magnetically interacting with magnet 132 to affix the utility tool to frame 100.

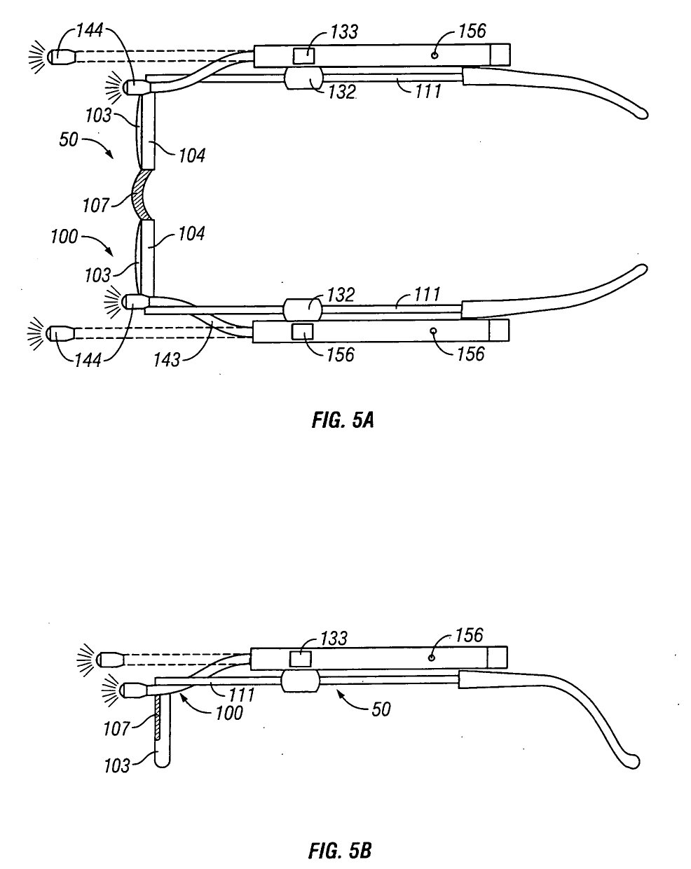

Referring additionally to FIGS. 5A and 5B, which are top and side views respectively, of one embodiment of the present invention, a tool system 50 comprising frame 100 having a common frame body 104, lens 103, nose rest 107, and rigid non-folding temple bars 111. In the embodiment as shown, tool system 50 further includes utility tools such as flashlight 140 each of which comprises a magnet 133 for magnetically interacting with magnet 132 to affix the utility tool to frame 100. Switch 156 is utilized to turn flashlight 140 on and off. Flashlight 140 further includes flexible neck 143 for positioning illumination device 144 (could be a bulb and/or LED) to direct light where desired.

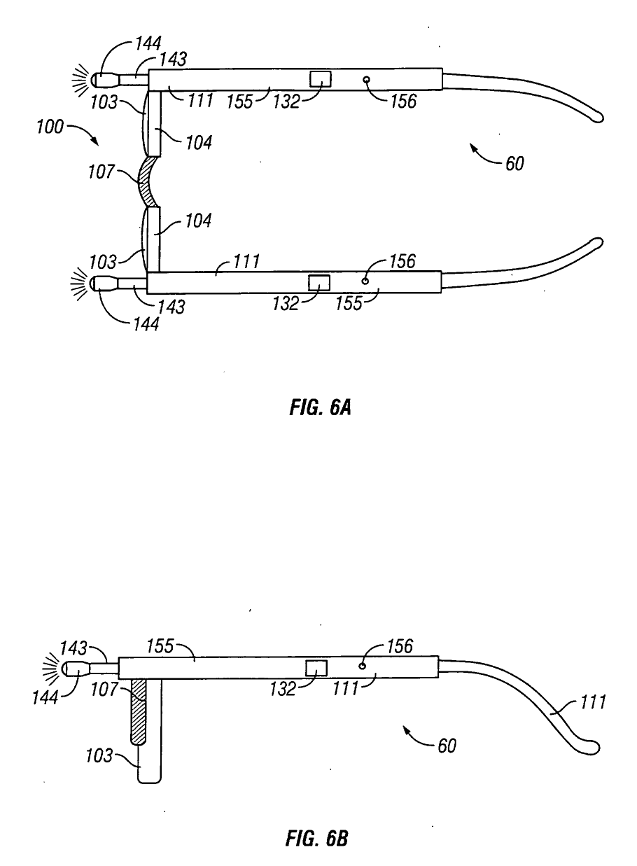

Referring additionally to FIGS. 6A and 6B, which are top and side views respectively, of one embodiment of the present invention, a tool system 60 comprising frame 100 having a common frame body 104, lens 103, nose rest 107, and rigid non-folding temple bars 111. Temple bars 111 comprise flashlight 155, either integral with temple bar 111 or housed therein, operable by switch 156. Flashlight 155 further includes flexible neck 143 for positioning bulb 144 to direct light where desired.

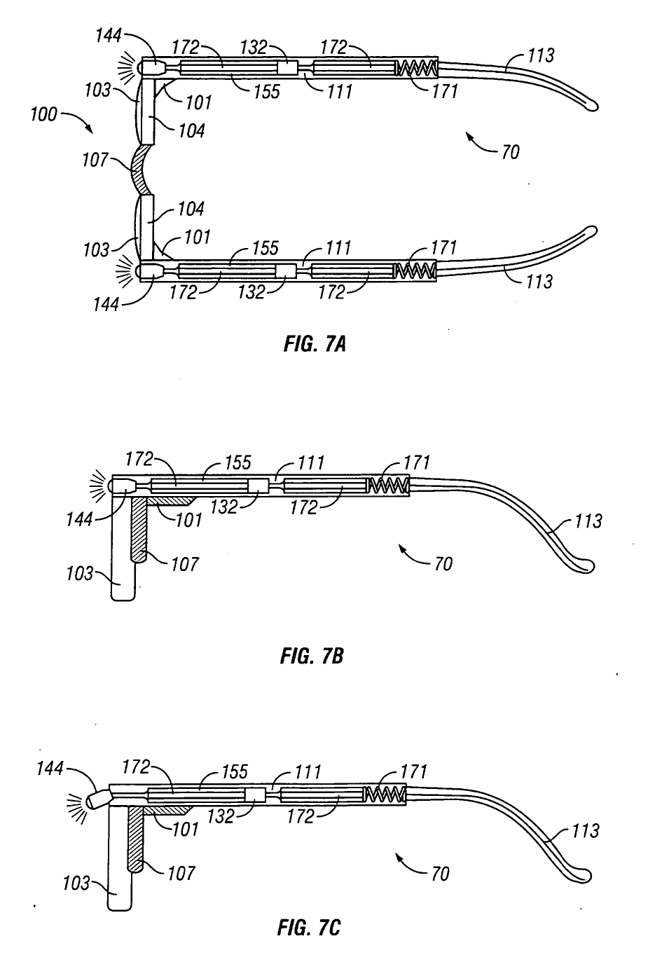

Referring additionally to FIGS. 7A and 7B, which are top and side views respectively, of one embodiment of the present invention, a tool system 70 comprising frame 100 having a common frame body 104, lens 103, nose rest 107, and rigid non-folding temple bars 111 (throughout, the temple bars may be hinged or rigidly attached). Temple bars 111 comprise flashlight 155, either integral with temple bar 111 or housed therein. Flashlight 155 further includes bulb 144, batteries 172 with magnet 133 positioned therebetween, and spring 171 for biasing batteries 172 together. Magnet 133 is conducting to allow current to pass between batteries 172. This magnet 133 may be conductive or provided with a conductive coating or conductive member. FIG. 7 shows an enlarged view of an alternative bulb 144 which may be pointable in desired directions.

Referring additionally to FIGS. 8A and 8B, which are top and side views respectively, of one embodiment of the present invention, a tool system 80 comprising frame 100 having a common frame body 104, lens 103, nose rest 107, temple bars 111, temple tips 113, and hinge spring 101. Mounted on temple bars 111 are magnets 132. In the embodiment as shown, tool system 80 further includes utility tools such as flashlight 140, each of which comprises a magnet 133 for magnetically interacting with magnet 132 to affix the utility tool to frame 100. Tool system 80 further includes a magnetic strap 181 for further affixing pen 140 to frame 100.

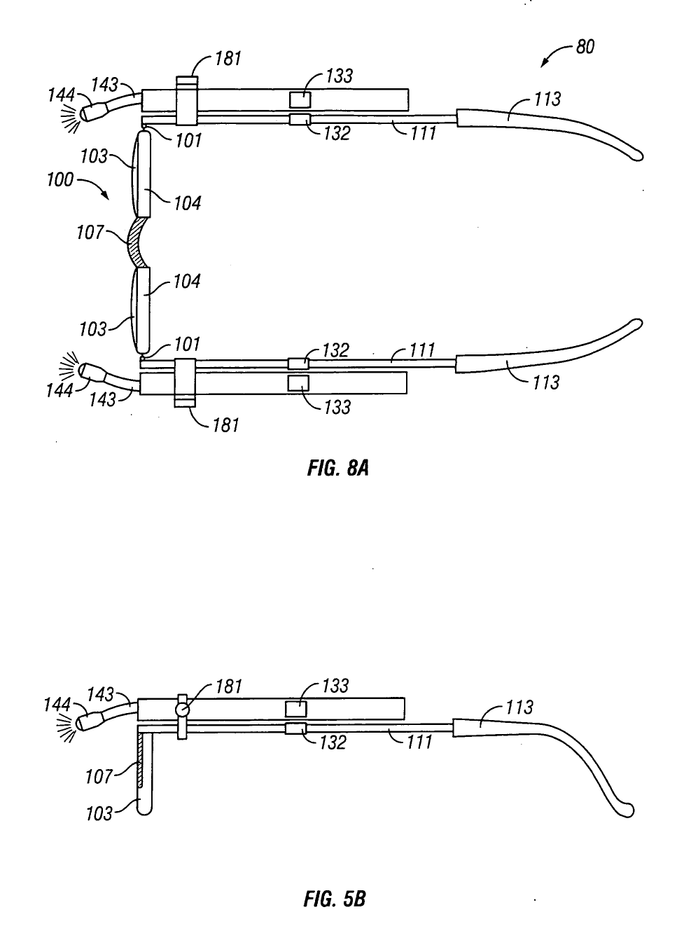

Referring additionally to FIGS. 89 and 9B, which are top and side views respectively, of one embodiment of the present invention, a tool system 90 comprising frame 100 having a common frame body 104, lens 103, nose rest 107, temple bars 111, and temple tips 113. Mounted on one of the temple bars 111 is a magnet 132, although more magnets could be utilized on both temple bars. In the embodiment as shown, tool system 80 further includes utility tools such as flashlight 140, which comprises a magnet 133 for magnetically interacting with magnet 132 to affix the utility tool to frame 100. FIGS. 9C, 9D and 9E show various configurations for repositioning bulb 144 by changing the shape of flexible member 143.

What is claimed is:

1. A tool system comprising:
an optical or non-optical frame;
a tool magnetically coupled to the frame.

2. The tool system of claim 1, wherein the tool comprises one selected from the group consisting of flashlights, writing instruments, mechanical tools, measurement instruments, audio attachments, kitchenware, and telescoping tools.

3. A tool system comprising:
An optical or non-optical frame comprising first magnetic coupling member; and
A tool comprising a second magnetic coupling member;
wherein the first magnetic coupling member and the second magnetic coupling member magnetically interact to magnetically couple the frame to the tool.

4. The tool system of claim 3, wherein the tool comprises one selected from the group consisting of flashlights, writing instruments, mechanical tools, measurement instruments, audio attachments, kitchenware, and telescoping tools.

5. The tool system of claim 3, wherein the first magnetic coupling member is slidably attached to the eyeglasses.

6. The tool system of claim 3, wherein the first magnetic coupling member is incorporated into the eyeglasses.

7. A temple bar for an optical or non-optical frame, comprising an elongated body member having a first end adapted for connection to the frame, a second end for shaping to fit over a wearer's ear, and a magnet supported to the elongated body member.

8. The temple bar of claim 7, further comprising a tool.
